(19) United States
(12) Patent Application Publication
(10) Pub. No.: US 2026/0280949 A1
(43) Pub. Date: Sep. 17, 2026

(54) PHASE-ROTATED PI/2 BPSK FOR MU-MIMO OPERATION

(71) Applicant: QUALCOMM Incorporated, San Diego, CA (US)

(72) Inventors: Vinayak SURESH, San Diego, CA (US); Jing JIANG, San Diego, CA (US); Juergen CEZANNE, Ocean Township, NJ (US); Peter GAAL, San Diego, CA (US); Yu ZHANG, San Diego, CA (US)

(21) Appl. No.: 19/557,886

(22) Filed: Mar. 5, 2026

Related U.S. Application Data
(60) Provisional application No. 63/772,200, filed on Mar. 14, 2025.

(51) Int. Cl. H04L 27/20; H04B 7/0413; H04W 72/232

(52) U.S. Cl. CPC H04L 27/20; H04B 7/0413; H04W 72/232

(57) ABSTRACT

Certain aspects of the present disclosure provide techniques for wireless communications by a device. A method generally includes receiving, from a network entity (NE), an indication of a pi/2-binary phase shift keying (BPSK) modulation configuration comprising a phase rotation factor, and communicating in accordance with the pi/2 BPSK modulation configuration.

### CROSS REFERENCE TO RELATED APPLICATION(S)

The present Application for Patent claims priority to and benefit of U.S. Provisional Patent Application No. 63/772,200, filed Mar. 14, 2025, which is hereby expressly incorporated by reference herein in its entirety.

### INTRODUCTION

### Field of the Disclosure

Aspects of the present disclosure relate to wireless communications, and more particularly, to techniques for transmitting a pi/2-binary phase shift keying (BPSK) modulation configuration for interference mitigation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a user equipment (UE). The method includes receiving, from a network entity (NE), an indication of a pi/2-binary phase shift keying (BPSK) modulation configuration comprising a phase rotation factor; and communicating in accordance with the pi/2 BPSK modulation configuration.

Certain aspects provide a method of wireless communications by a NE. The method includes sending, to a UE, an indication of a pi/2-BPSK modulation configuration comprising a phase rotation factor; and communicating with the UE in a multiple user multiple-input multiple-output (MU-MIMO) communication mode in accordance with the pi/2 BPSK modulation configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a block diagram illustrating an exemplary wireless communication system supporting OFDM or DFT-s-OFDM communication.

FIG. 6 depicts wo block diagrams of processing apparatus where Frequency-Domain Spectral Shaping (FDSS) filtering is applied to data and reference signaling.

FIG. 7 depicts example constellation points for a binary phase shift keying (BPSK) modulation scheme and a pi/2 BPSK modulation scheme.

FIG. 8. depicts diagram illustrating multi-user (MU) communications between multiple UEs and a network entity.

FIG. 9. depicts a process flow for communications in a network between a network entity and a user equipment for transmitting a pi/2 BPSK modulation configuration for interference mitigation.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for transmitting a pi/2-binary phase shift keying (BPSK) modulation configuration for interference mitigation.

Wireless communication systems use different multiplexing and multiple access algorithms. In particular, orthogonal frequency division multiplexing (OFDM) has gained widespread adoption due to advantages such as a high spectral efficiency and low susceptibility to multipath fading. However, OFDM waveforms generally have a high peak-to-average power ratio (PAPR) relative to other multiplexing and multiple access algorithms. When transmitting signals, reducing the PAPR is generally desired to improve the efficiency and reduce clipping or other undesirable effects at transmitting devices, such as a user equipment (UE).

For example, discrete Fourier transform-spread-OFDM (DFT-s-OFDM) waveforms exhibit a lower PAPR than OFDM waveforms, and for this reason, are often utilized for uplink transmissions in wireless communication systems.

In addition, different waveform modulation techniques can affect the PAPR. As an example, phase key shifting (PSK) is a class of modulation techniques for changing a phase of a carrier wave. In particular, binary PSK (BPSK) uses two phases that are separated by 180° in phase. Each phase represents a binary “0” or “1” for a modulated signal. However, BPSK suffers from “zero crossings” when the bit stream changes from “0” to “1” or “1” to “0”. This causes the signal envelope (amplitude) to pass through zero, resulting in higher PAPR. Pi/2 BPSK modulation instead rotates the constellation points by pi/2 (90°) on the complex plane in alternating symbols, thereby avoiding zero crossings and reducing the PAPR compared to other modulation schemes such as standard BPSK on the real axis or quadrature amplitude modulation (QAM). This PAPR advantage is further augmented when pi/2-BPSK modulation is used with filtering.

In some cases, multiple UEs using pi/2 BPSK modulation may simultaneously send transmissions to the same network entity (NE). If a UE and a co-scheduled UE each apply a common phase rotation to their transmitted signals over channels having the same initial phase, then the set of constellation points for each of the UE and the co-scheduled UE will collide along one dimension, meaning that a first constellation point and a second constellation point occur at a same in-phase (“I”) component or a same quadrature (“Q”) component. This causes increased interference at the NE receiving the transmitted signals from the UE and the co-scheduled UE. The interference degrades performance of the UE, the co-scheduled UE, and the NE. Accordingly, a technical problem arises with respect to how to mitigate interference due to a UE and a co-scheduled UE using pi/2 BPSK modulation to apply the same phase rotation to their transmissions to the same network entity.

Certain aspects herein provide a technical solution to this technical problem, such as by providing techniques for transmitting a pi/2 binary phase shift keying (BPSK) modulation configuration including a phase rotation factor. As used herein, a “phase rotation factor” refers to a complex scalar that is applied to a signal to shift its phase by a given angle without altering its magnitude. For example, the NE may send a DCI message indicating a pi/2 BPSK modulation configuration that includes a phase rotation factor that, when applied by the UE, provides improved orthogonality (e.g. improved partial orthogonality, near orthogonality, or full orthogonality) between a signal originating from the UE and a signal originating from a co-scheduled UE. The pi/2 BPSK modulation configuration thus mitigates interference experienced at the NE, thereby providing the technical benefit of improving throughput and/or reliability at the UE, the co-scheduled UE, and the NE.

In some examples, a UE and a co-scheduled UE may communicate using an MU-MIMO operation mode, such that first UE 804 and second UE 806 each utilize two or more transmitting antennas to simultaneously transmit data to network entity. The NE may determine based on channel information received from the UEs that they are communicating using channels having identical phase shifts (or phase shifts that are within a threshold relative phase with one another, or phase shifts that cause a threshold level of interference with one another) while applying the same phase rotation to their respective transmitted signals. The NE may then send a DCI message to the UE including a pi/2 BPSK configuration that includes one or more phase rotation factors. The one or more phase rotation factors may be configured to provide orthogonality between signals originating from the UE and signals originating from the co-scheduled UE, such as by causing the UE to apply a phase rotation to its transmitted signals. The UE may then communicate in accordance with the pi/2 BPSK configuration, thereby mitigating interference at the NE due to ensuring orthogonality between signals originating from the UE and signals originating from the co-scheduled UE. This provides the technical benefit of improving throughput and/or reliability at the UE, the co-scheduled UE, and the NE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

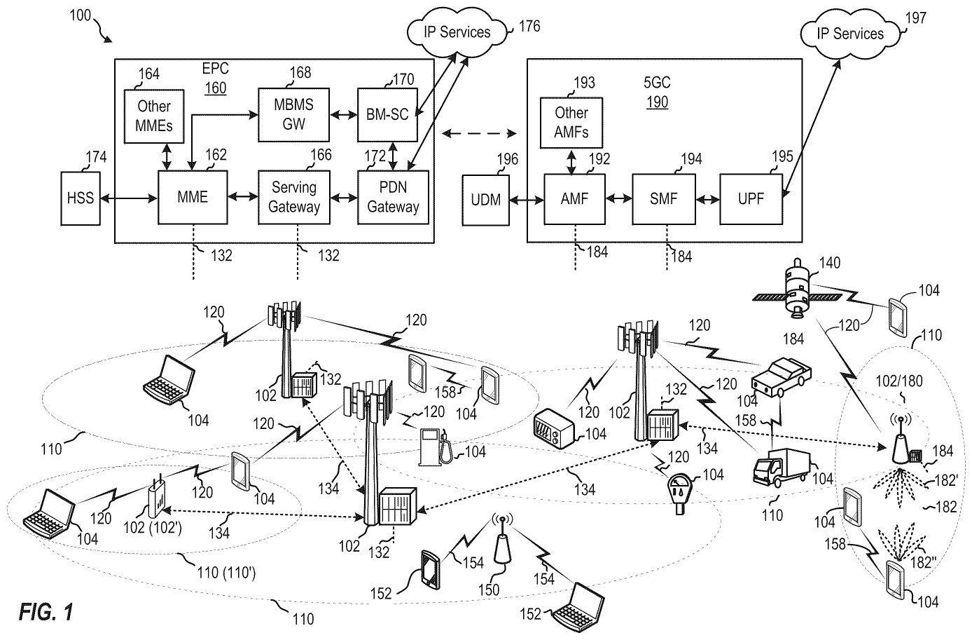

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

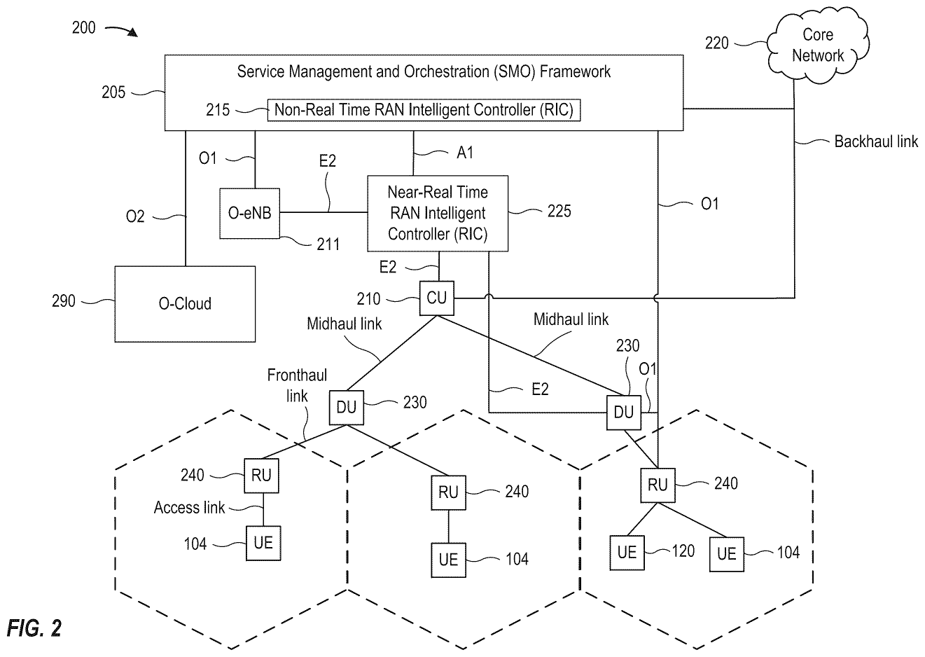

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz- 7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

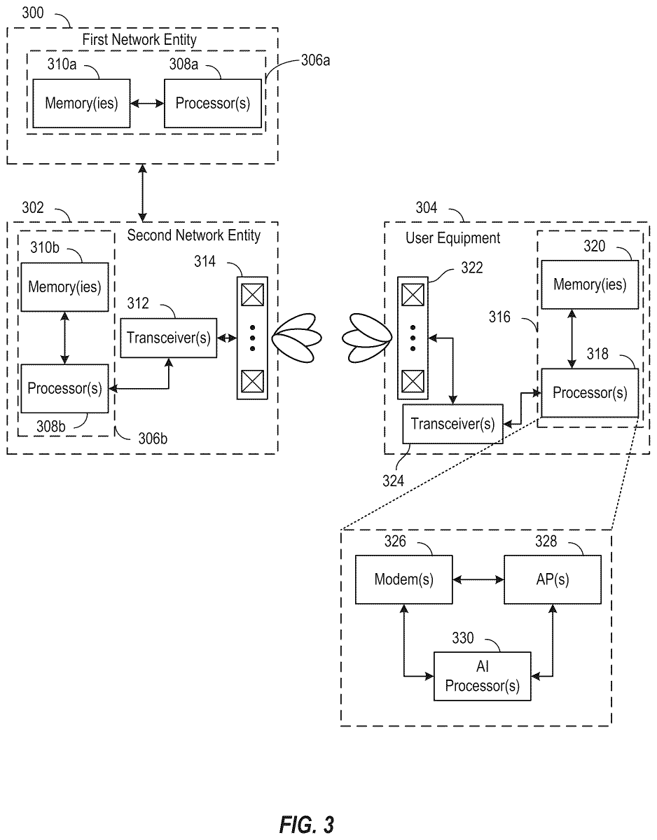

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

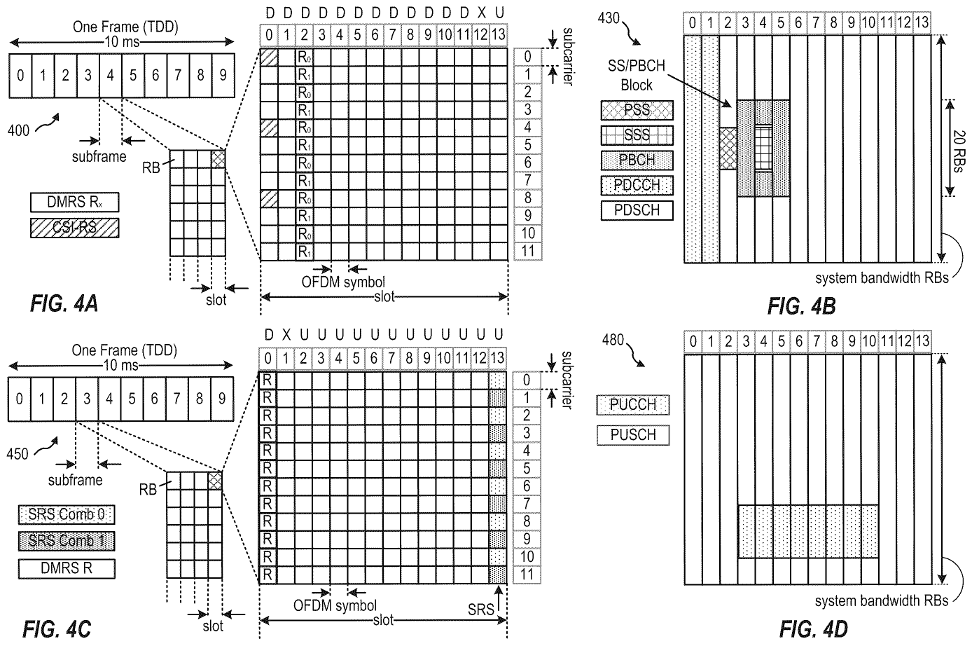

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Techniques for Transmitting a Pi/2 BPSK Modulation Configuration for Interference Mitigation

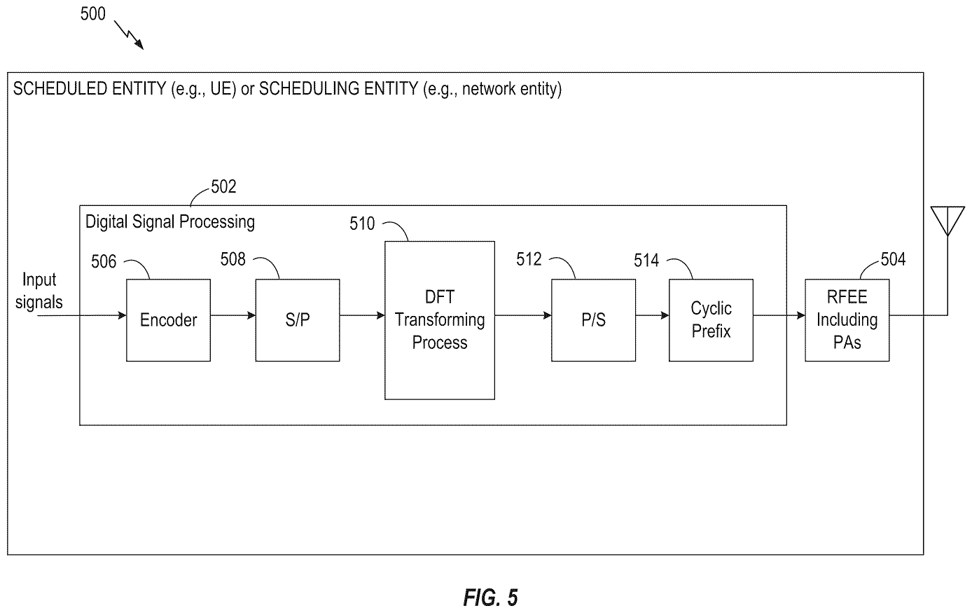

FIG. 5 depicts a block diagram illustrating an exemplary wireless communication system 500 supporting OFDM or DFT-s-OFDM communication in which the present methods and apparatus may be employed. System 500 may be a UE in some examples, and configured for both transmitting uplink (UL) transmissions and receiving downlink (DL) transmissions. In particular, FIG. 5 illustrates various components used by the system 500 for transmission of signals, including a digital signal processing component 502 that receives data signal information and other information (e.g., pi/2-BPSK sequences) from other processing circuitry (not shown) and processes the signals into baseband signals that are, in turn, transmitted at radio frequency (RF) via an RF front-end (RFFE) component 504 including one or more power amplifiers (PA) and coupled to an antenna for wireless transmission.

The digital signal processing component 502 may include: an encoder 506 that encodes the received input signal information; a serial to parallel block converter 508 that takes the serial stream of input data and establishes a number of parallel information samples; and a discrete Fourier transform (DFT) processing component 510 that receives the number of parallel information samples of the signals from their original domain (e.g., time or space domain) and converts the signals to a representation in the frequency domain for mapping to the various OFDM or DFT-s-OFDM frequencies or tones. Parallel to serial converter 512 then converts back into the time domain and back to a serialized data stream for transmission via RF modulation techniques, which also includes digital to analog conversion. The processing component 502 may also include a cyclic prefix (CP) insertion block 514 for adding a CP between transmitted symbols.

According to some other examples, the processing portion 502 may also include low PAPR modulation either prior to or after the DFT processing by DFT processing component 510 (not illustrated in FIG. 5), such as filtered pi/2-BPSK modulation, which may include the use of a finite impulse response (FIR) or other smoothing filter with the modulation. Filtering applied before the DFT processing may be in the time domain (convolution) and filtering applied after the DFT processing may be in the frequency domain (multiplication). The addition of such modulation affords a reduction in PAPR in order to improve PA efficiency. This is accomplished by causing the PA to operate in the non-linear region close to a saturation point. To implement this, the transmitted waveform may have a very small PAPR (ideally at 0 dB).

Different modulation techniques can result in different PAPRs for the same data. Various modulation techniques used in wireless telecommunications include amplitude-shift keying (ASK), frequency shift keying (FSK), PSK, and quadrature amplitude modulation (QAM), as examples. Concerning PSK, a form of PSK known as BPSK uses two phases that are separated by 180° in phase to respectively represent a binary “0” or “1” for the modulated signal. While BPSK typically maps the two constellation points on the real axis of the real/imaginary plane (e.g., at 0° and 180°), it does not matter exactly where constellation points are positioned in the complex plane, and the rotation of these points for other variants of BPSK are possible, and such variants may be beneficial for modulation of signals in terms of PAPR, especially when combined with filtering. As discussed above, pi/2-BPSK modulation rotates the constellation points by pi/2 (90°) on the complex plane in alternating symbols. This modulation has been shown to reduce the PAPR compared to other modulation schemes such as standard BPSK on the real axis or QAM. This PAPR advantage is further augmented when pi/2-BPSK modulation is used with filtering.

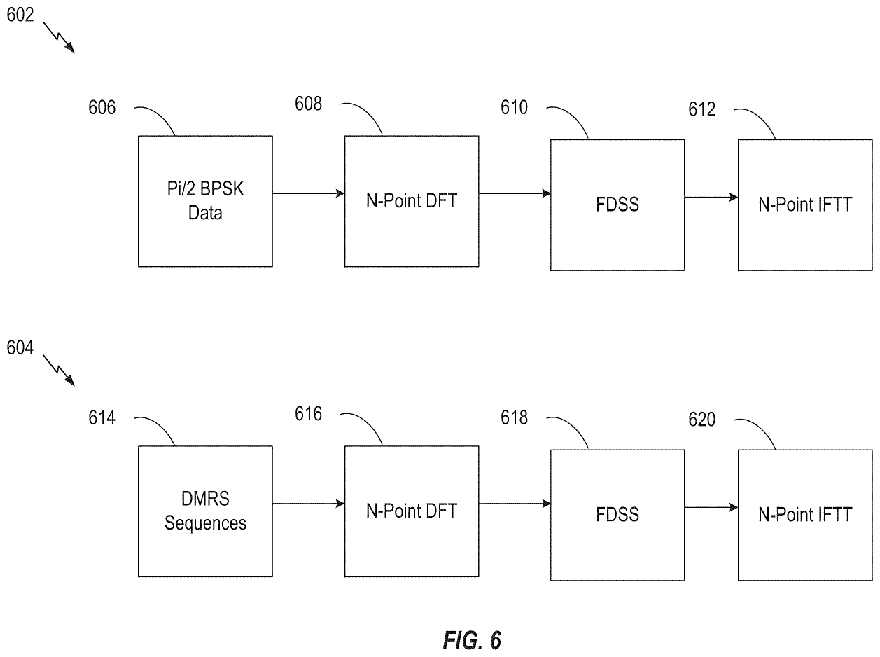

FIG. 6 depicts two block diagrams of processing apparatus 602 and 604 where frequency-domain spectral shaping (FDSS) filtering is applied to both data, such as pi/2-BPSK modulated data, and transmitted signals, such as DMRS signaling. As shown, apparatus 602 receives input data 606 (e.g., pi/2-BPSK modulated data), which is then discrete Fourier transformed (DFT) to N points in the frequency domain as shown by block 608. The output of DFT performed at block 608 is then filtered using FDSS, in this example, as shown with FDSS block 610. The samples are then inverse discrete Fourier transformed to the time domain as shown by block 612.

Similarly, apparatus 604 receives input reference signaling 614 (e.g., DMRS sequences), which is then discrete Fourier transformed to N points in the frequency domain, as shown by block 616. The output of DFT performed at block 616 is then filtered using Frequency-Domain Spectral Shaping (FDSS), in this example, as shown by FDSS block 618. The samples are then inverse discrete Fourier transformed to the time domain as shown by block 620.

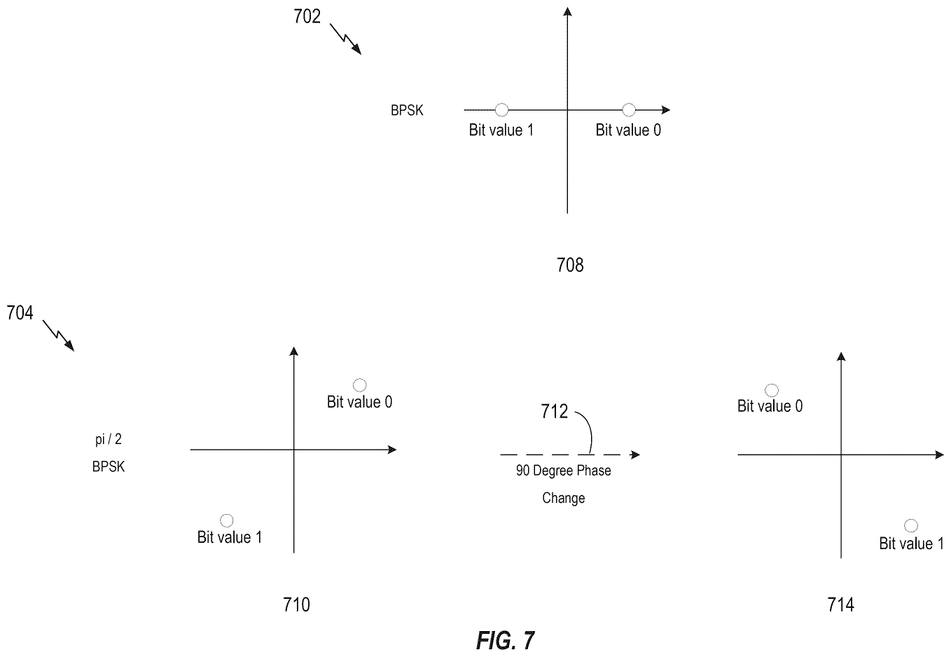

FIG. 7 depicts two diagrams including example constellation points for a BPSK modulation scheme and a pi/2 BPSK modulation scheme. In FIG. 7, the horizonal axis is a real (in-phase) axis and the vertical axis is an imaginary (quadrature) axis.

A first diagram 702 depicts constellation points for a BPSK modulation scheme. As shown, a first BPSK constellation 708 includes two distinct constellation points on a real axis of a complex plane, each representing a different selectable value for a set of modulation symbols. In this case, the two constellation points are positioned at +1 and −1 respectively, which is equivalent to 0 degrees and 180 degrees. Since in the first diagram 702, BPSK modulation does not use the imaginary axis, the transmitted signals are purely real valued. This simplistic structure using a static pair of constellation points for all symbols makes BPSK robust to noise and phase distortions, increasing reliability in low signal-to-noise ratio scenarios. Note that the two constellation points can be positioned in a fashion other than on the real axis, such as on the imaginary axis.

However, BPSK exhibits an amount of PAPR, particularly in the presence of multiple carrier systems, such as OFDM. As discussed above, waveforms sent using BPSK undergo abrupt and frequent 180-degree phase changes, leading to frequent zero crossing in the time-domain. For example, if the bit stream changes from “0 ” to “1” or “1” to “0” between consecutive modulation symbols, the 180-degree phase change results in a zero crossing each time the bit stream changes. The zero crossings create peaks when summed across subcarriers, causing increased PAPR, thereby reducing power amplifier efficiency.

A second diagram 704 depicts constellation points for a pi/2 BPSK modulation scheme. As shown, a first pi/2 BPSK constellation 710 similarly includes two distinct constellation points that each correspond to a selectable value for a given modulation symbol. At 712, a 90-degree phase change occurs between consecutive modulation symbols to obtain a second pi/2 BPSK constellation 714 including two different selectable constellation points for a next consecutive modulation symbol. Thus, after each symbol, a transmitter may switch between the first pi/2 BPSK constellation 710 and the second pi/2 BPSK constellation 714, which simplifies synchronization.

Because the phase change is only 90 degrees, as compared to BPSK modulation having phase changes of 180 degrees, the zero crossings associated with BPSK modulation are avoided, thereby reducing the PAPR. The reduced PAPR associated with the pi/2 BPSK modulation scheme allows the amplifier to use higher average operating point without experiencing distortion. Smaller phase changes between consecutive symbols also provides the benefit of reducing the magnitude of the side lobes in the frequency domain.

In some cases, multiple UEs using pi/2 BPSK modulation may simultaneously send transmissions to the same network entity (NE) while applying the same phase rotation to their respective transmissions. This may cause interference at the NE between the transmissions of the multiple UEs, thereby degrading performance and affecting throughput and reliability at the multiple UEs and the NE.

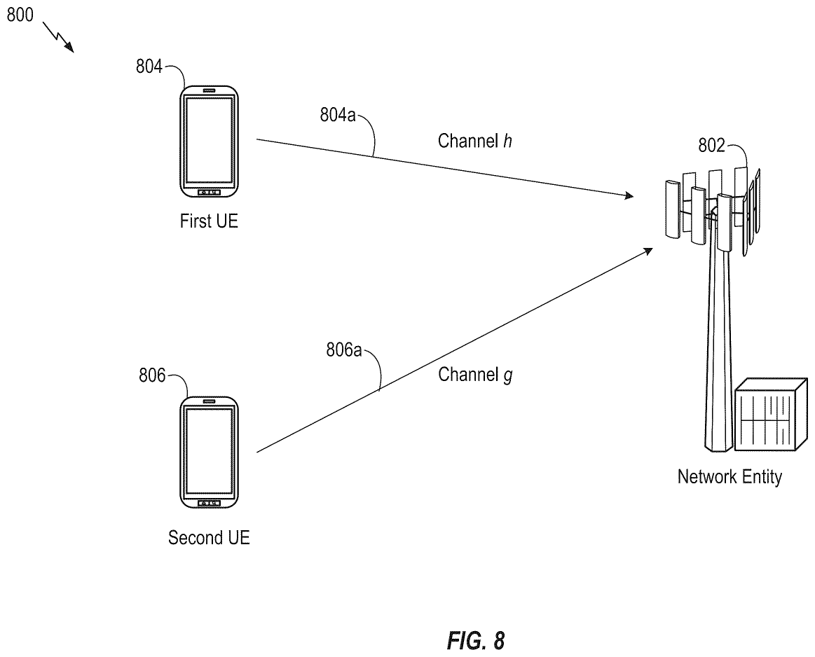

FIG. 8 is a diagram illustrating an example 800 of multi-user (MU) communications between multiple UEs and a network entity. More specifically, example 800 incudes a network entity 802 in communication with a first UE 804, and a second UE 806.

In some aspects, network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, first UE 804 and second UE 806 may be an example of UE 104 depicted and described with respect to FIG. 1 or the UE 304 depicted and described with respect to FIG. 3. However, in other aspects, first UE 804 and second UE 806 may be another type of wireless communications device and network entity 802 may be another type of network entity or network node, such as those described herein.

First UE 804 and second UE 806 may each communicate with network entity 802 using one or more transmitting (Tx) antennas for sending transmissions over a wireless channel. For example, at 804a, first UE 804 may send transmissions to network entity 802 over a channel “h”. Similarly, at 806a, second UE 806 may send transmissions to network entity 802 over a channel “g”. Channel “h” and channel “g” may exhibit phase coherence. As used herein, “phase coherence” refers to a condition where the phase difference between two channels remains constant over time (and optionally frequency) such that any signals transmitted over the channels maintain a fixed phase relationship, such that any transmissions sent over the channels align in phase. The phase of (h/g) may be represented as 0, such that the channels have the same phase.

In some examples, first UE 804 and second UE 806 may each send transmissions using a singular transmit antenna. In other examples, first UE 804 and second UE 806 may be associated with an MU-MIMO operation mode, such that first UE 804 and second UE 806 each utilize two or more transmitting antennas to simultaneously transmit a single layer of data to network entity 802. For example, first UE 804 may use beamforming to transmit a single layer of data by applying a precoding scheme (e.g. selected from a predefined codebook) to two transmitting antennas for adjusting phase and amplitude to direct the signal towards network entity 802. In some cases, second UE 806 may be a co-scheduled UE configured to communicate with network entity 802 using the same time-frequency resources as first UE 804 in the MU-MIMO operation mode. In other examples, first UE 804 and second UE 806 operating in the MU-MIMO operation mode may use multiple antennas to transmit multiple layers of data.

First UE 804 and second UE 806 may each employ pi/2 BPSK modulation schemes. In some cases, first UE 804 and second UE 806 may apply the same phase rotation to a set of pi/2 BPSK modulation symbols for respective transmissions to be sent to network entity 802. This causes transmissions sent by first UE 804 and second UE 806 to include constellation points that collide or overlap when received by network entity 802, thereby causing interference. The interference at network entity 802 degrades performance, reducing throughput and reliability for network entity 802, and/or for first UE 804 and second UE 806.

Example 800 thus demonstrates a technical problem with respect to how to mitigate interference when a UE and a co-scheduled UE using pi/2 BPSK modulation send transmissions having the same applied phase rotation to the same network entity. Certain aspects herein provide a technical solution to this technical problem, such as by providing techniques for transmitting a pi/2 BPSK modulation configuration including a phase rotation factor, thereby providing the technical benefit of improving throughput and reliability at the network entity and/or the UE and co-scheduled UE, as will be described in greater detail below.

### Example Signaling of a Pi/2-BSPSK Modulation Configuration for Interference Mitigation

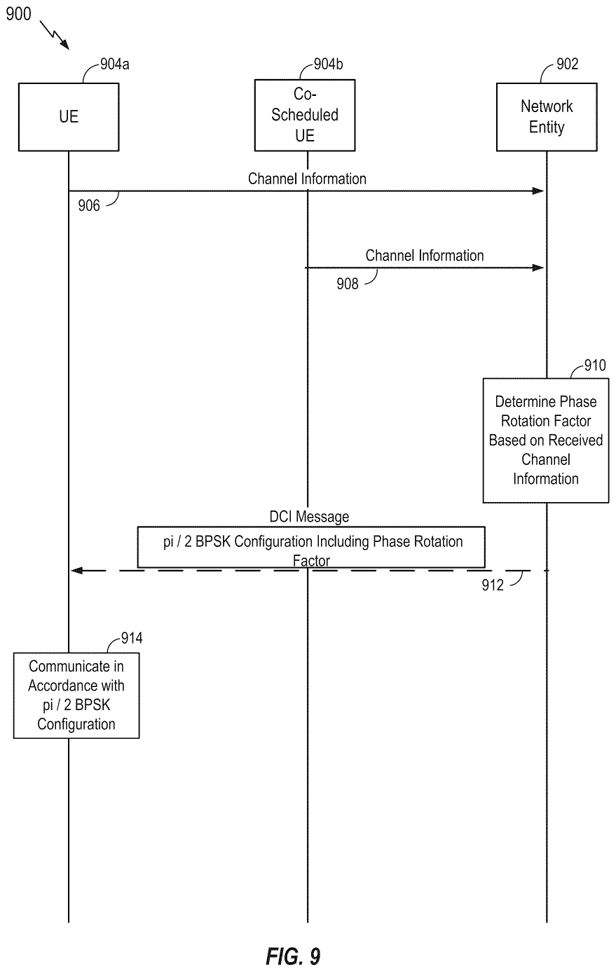

FIG. 9 depicts a process flow 900 for communications in a network between a network entity 902, a UE 904a, and a co-scheduled UE 904b. UE 904 and co-scheduled UE 904b each employ a pi/2 BPSK modulation scheme. In certain aspects, process flow 900 may enable network entity 902 to transmit a pi/2 BPSK modulation configuration including a phase rotation factor to UE 904a, such that UE 904a may communicate in accordance with the pi/2 BPSK modulation configuration, thereby ensuring improved orthogonality (e.g. improved partial orthogonality, near orthogonality, or full orthogonality) between data streams of UE 904a and co-scheduled UE 904b. This provides the technical benefit of improving throughput and reliability at network entity 902 and/or UE 904a and co-scheduled UE 904b.

In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, UE 904a and co-scheduled UE 904b may be an example of UE 104 depicted and described with respect to FIG. 1 or the UE 304 depicted and described with respect to FIG. 3. However, in other aspects, UE 904a and co-scheduled UE 904b may be another type of wireless communications device and network entity 902 may be another type of network entity or network node, such as those described herein. Note that any operations or signaling illustrated with dashed lines may indicate that that operation or signaling is an optional or alternative example.

At 906, UE 904a sends channel information to network entity 902. The channel information may include a phase rotation being applied by UE 904a to a set of pi/2 BPSK modulation symbols for a first transmission associated with UE 904a, such as a first transmission being sent over a given logical channel from UE 904a to network entity 902. In aspects, the channel information may be sent from UE 904a to network entity 902 within an uplink reference signal, such as a sounding reference signal (SRS) for carrying phase rotation information. In some aspects, the network entity 902 may determine the channel information using the SRS. For example, the network entity 902 may measure the phase rotation according to the SRS. In some aspects, the channel information may include channel state information or the like.

At 908, co-scheduled UE 904b also sends channel information to network entity 902. Co-scheduled UE 904b may send channel information to network entity 902 using similar means as described above at 906.

At 910, network entity 902 determines a phase rotation factor to indicate to UE 904a. Network entity 902 may determine the phase rotation factor to indicate to UE 904a based on the channel information received from UE 904a and co-scheduled UE 904b at 906 and 908. For example, network entity 902 may receive a first SRS associated with a first channel of UE 904a and a second SRS associated with a second channel of co-scheduled UE 904b which indicate or are used to determine the phase rotation to indicate to UE 904a. Network entity 902 may further use the received channel information to determine whether a first channel being used by UE 904a and a second channel being used by co-scheduled UE 904b exhibit phase coherence. For example, the channel information received by network entity 902 may indicate a first channel used by UE 904a and a second channel used by co-scheduled UE 904b are aligned based on having identical phase shifts, and that the identical phase shifts remain unchanged over time. Accordingly, network entity 902 may determine a phase rotation factor to indicate to UE 904a that UE 904a may apply to one or more modulation symbols of one or more transmissions to provide improved orthogonality between the one or more transmissions of UE 904a and one or more transmissions of co-scheduled UE 904b.

At 912, network entity 902 sends, to UE 904a, a downlink control information (DCI) message that indicates a pi/2 BPSK configuration. The pi/2 BPSK configuration includes a phase rotation factor. The phase rotation factor may be configured to provide improved orthogonality (e.g. improved partial orthogonality, near orthogonality, or full orthogonality) between a transmission of UE 904a and a transmission of co-scheduled UE 904b. For example, if a first channel used by UE 904a has the same phase as a second channel used by co-scheduled UE 904b, the phase rotation factor may be configured to apply a phase rotation of 90 degrees to a transmission sent over the first channel used by UE 904a to provide improved orthogonality.

In certain aspects, the phase rotation factor corresponds to a codebook index selected from a codebook. The codebook may include a set of values mapped to a set of phase rotation factors. In some examples, the phase rotation factor may be any value for improving orthogonality between transmissions of UE 904a and co-scheduled UE 904b. For example, if the phase of the channels used by UEs 904 a, 904 b are offset by 30 degrees, then network entity 902 may select phase rotation factor corresponding to a 60-degree phase shift such that, after application of the phase rotation factor at UE 904a, the phases of the channels are separated by 90 degrees. In aspects, the DCI message may include one or more bits that indicate the selected phase rotation factor. In some examples, the selected phase rotation factor may be indicated in a transmission precoding matrix indicator (TPMI) field of the DCI message. In certain aspects, the pi/2 BPSK configuration may include two or more phase rotation factors to be applied to two or more different data streams being transmitted by UE 904a to provide improved orthogonality (e.g. improved partial orthogonality, near orthogonality, or full orthogonality) orthogonality with one or more transmissions of co-scheduled UE 904b.

At 914, UE 904a communicates in accordance with the pi/2 BPSK modulation configuration, such as by applying a phase rotation factor (included within the pi/2 BPSK modulation configuration) to a set of pi/2 BPSK modulation symbols of a transmission. In some cases, UE 904a may communicate using a single transmitting antenna by applying the phase rotation factor to a set of pi/2 BPSK modulation symbols for a single layer. In some other cases, UE 904a may communicate in an MU-MIMO operation mode using two or more antennas to transmit a single layer of data having the phase rotation factor. UE 904a may then apply the phase rotation factor from the pi/2 BPSK modulation configuration to a set of pi/2 BPSK modulation symbols corresponding to the single layer of data. The constellation points for transmissions sent by UE 904a will thus rotate in accordance with the phase rotation factor of the pi/2 BPSK modulation configuration, allowing UE 904a to send the first transmission using two or more transmitting antennas, thereby ensuring improved orthogonality between data streams of UE 904a and co-scheduled UE 904b. In some cases, UE 904a may use two or more transmitting antennas to transmit two or more data streams in accordance with a received pi/2 BPSK configuration. For example, UE 904a may apply a first phase rotation factor to a first transmission and a second phase rotation factor to a second transmission. Each of the first and second phase rotation factors may be applied to improve orthogonality between each of the first transmission and the second transmission with a third transmission associated with co-scheduled UE 904b, such as a transmission sent from co-scheduled UE 904b to network entity 902.

In other aspects, the pi/2 BPSK modulation configuration is based on the UE having a capability for coherent transmission over time. A capability for coherent transmission over time may indicate that a given UE can perform a transmission (or a series of transmissions) over a defined length of time, and that a difference in a phase at a beginning of the transmission and a phase at an end of the transmission is less than a threshold. For example, UE 904a and co-scheduled UE 904b may each maintain their phase over time throughout the duration of a given transmission such that the constellation points used by each of UE 904a and co-scheduled UE 904b occur at a same in-phase component or a same quadrature component, thereby causing interference. UE 904a may then communicate in accordance with the pi/2 BPSK modulation configuration to apply a phase rotation factor to provide improved orthogonality between its transmissions and transmissions originating from co-scheduled UE 904b. This provides the technical benefit of improving throughput and reliability at network entity 902 and/or UE 904a and co-scheduled UE 904b.

Note that the process flow illustrated in FIG. 9 is described herein to facilitate an understanding of techniques for transmitting a pi/2 BPSK modulation configuration for interference mitigation, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

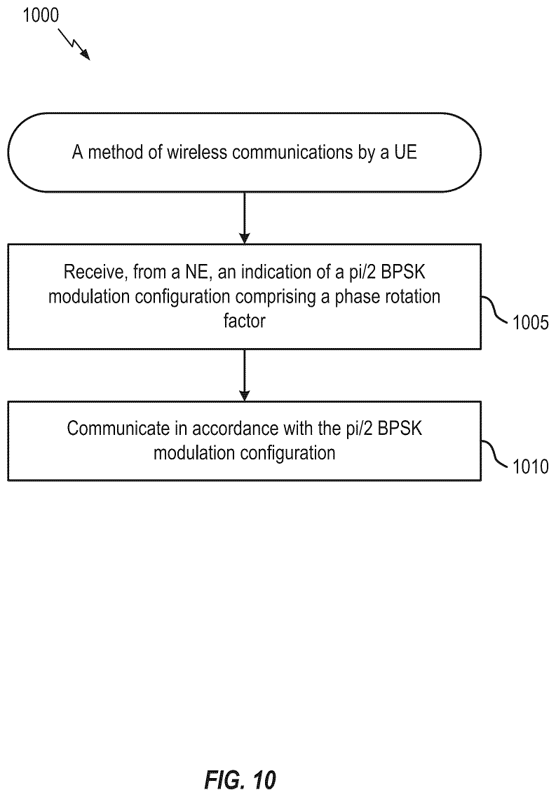

FIG. 10 shows a method 1000 for wireless communications by a UE, such as UE 104 of FIG. 1 or UE 304 of FIG. 3.

Method 1000 begins at block 1005 with receiving, from a NE, an indication of a pi/2 BPSK modulation configuration comprising a phase rotation factor. For example, the receiving of the indication of the pi/2 BPSK modulation configuration could correspond to 912 of FIG. 9.

Method 1000 then proceeds to block 1010 with communicating in accordance with the pi/2 BPSK modulation configuration. For example, the communicating in accordance with the pi/2 BPSK modulation configuration could correspond to 914 of FIG. 9. Method 1000 thus allows a UE to communicate in accordance with a pi/2 BPSK modulation configuration by applying a phase rotation factor included within the pi/2 BPSK modulation configuration to provide improved orthogonality (e.g. improved partial orthogonality, near orthogonality, or full orthogonality)between data streams of the UE and a co-scheduled UE. This provides the technical benefit of improving throughput and reliability at the network entity and/or the UE and the co-scheduled UE.

In some aspects, block 1010 includes communicating in a multiple user MIMO operation mode.

In some aspects, the multiple user MIMO operation mode is associated with the UE and a co-scheduled UE.

In some aspects, the phase rotation factor corresponds to a codebook index selected from a codebook, the codebook comprising a set of values mapped to a set of phase rotation factors.

In some aspects, the pi/2 BPSK modulation configuration is indicated via a DCI message, wherein the DCI message comprises one or more bits that indicate the phase rotation factor.

In some aspects, the phase rotation factor is indicated in a TPMI field of the DCI message.

In some aspects, the pi/2 BPSK modulation configuration is based on the UE having a capability for coherent transmission over time.

In some aspects, block 1010 includes: applying the phase rotation factor to a first transmission associated with a first transmitting antenna; and applying a second phase rotation factor to a second transmission associated with a second transmitting antenna, wherein the second phase rotation factor is indicated by the pi/2 BPSK modulation configuration.

In some aspects, the phase rotation factor is equal to the second phase rotation factor.

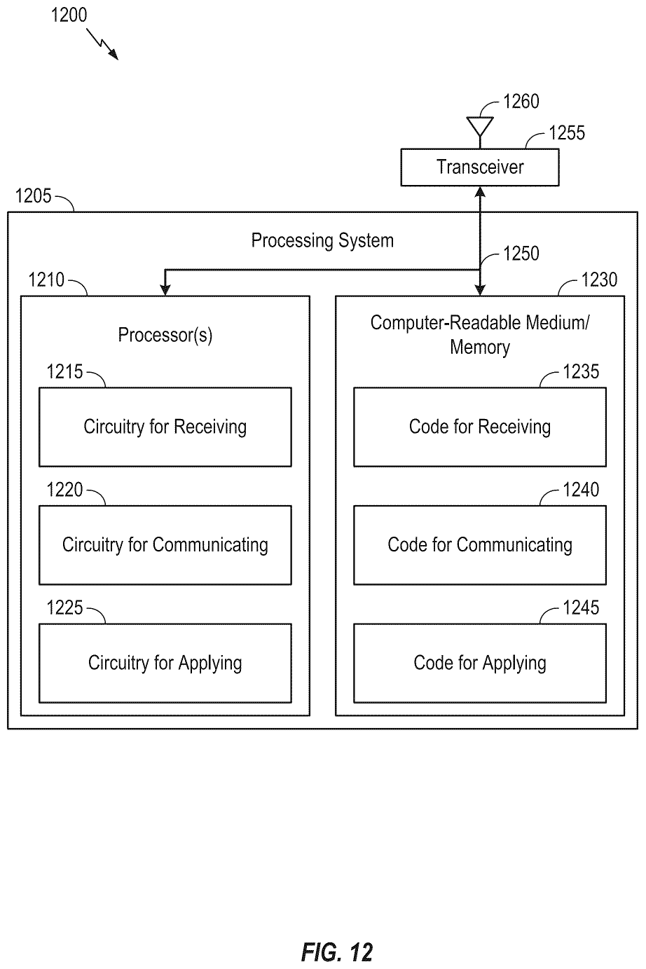

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

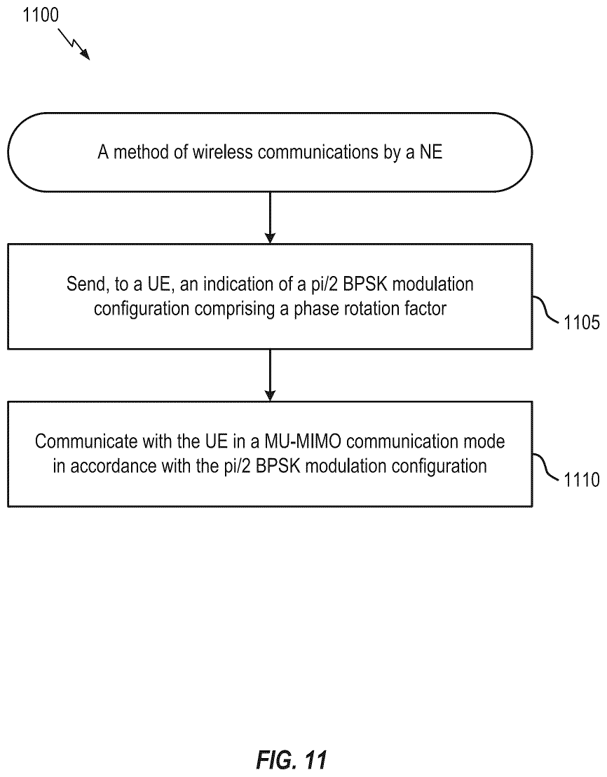

FIG. 11 shows a method 1100 for wireless communications by a NE, such as BS 102 of FIG. 1, a first network entity 300 or second network entity 302 of FIG. 3, or a disaggregated base station as discussed with respect to FIG. 2.

Method 1100 begins at block 1105 with sending, to a UE, an indication of a pi/2 BPSK modulation configuration comprising a phase rotation factor. For example, the sending of the indication of the pi/2 BPSK modulation configuration comprising the phase rotation factor could correspond to 912 of FIG. 9. Method 1100 thus allows a network entity to send a UE a pi/2 BPSK modulation configuration including a phase rotation factor usable by the UE to provide improved orthogonality (e.g. improved partial orthogonality, near orthogonality, or full orthogonality) between its transmissions and one or more transmissions of a co-scheduled UE. This provides the technical benefit of improving throughput and reliability at the network entity and/or the UE and the co-scheduled UE.

Method 1100 then proceeds to block 1110 with communicating with the UE in a MU-MIMO communication mode in accordance with the pi/2 BPSK modulation configuration.

In certain aspects, method 1100 further includes determining that a first phase rotation for a first transmission associated with the UE aligns with a second phase rotation for a second transmission associated with a co-scheduled UE based on a first SRS associated with a first channel of the UE and a second SRS associated with a second channel of the co-scheduled UE, wherein the phase rotation factor is based on the first phase rotation or the second phase rotation.

In certain aspects, method 1100 further includes sending, to a co-scheduled UE associated with an MU-MIMO communication, another indication of another pi/2 BPSK modulation configuration comprising a second phase rotation factor.

In some aspects, the phase rotation factor corresponds to a codebook index selected from a codebook, the codebook comprising a set of values mapped to a set of phase rotation factors.

In some aspects, the pi/2 BPSK modulation configuration is indicated via a DCI message, wherein the DCI message comprises one or more bits that indicate a selected phase rotation factor.

In some aspects, the phase rotation factor is indicated in a TPMI field of the DCI message.

In some aspects, the phase rotation factor causes a first transmission associated with the UE to be orthogonal to a second transmission associated with a co-scheduled UE, wherein the co-scheduled UE and the UE are associated with an MU-MIMO communication.

In some aspects, the pi/2 BPSK modulation configuration is based on the UE and the co-scheduled UE having a capability for coherent transmission over time.

In some aspects, the pi/2 BPSK modulation configuration comprises: the phase rotation factor for a first transmission associated with a first transmitting antenna of the UE; and a second phase rotation factor for a second transmission associated with a second transmitting antenna of the UE, wherein the second phase rotation factor is indicated by the pi/2 BPSK modulation configuration.

In some aspects, the phase rotation factor and the second phase rotation factor are associated with respective indicated codebook indexes selected from a codebook, the codebook comprising a set of values mapped to a set of phase rotation factors.

In some aspects, the second phase rotation factor causes the second transmission to be orthogonal to a third transmission associated with a co-scheduled UE.

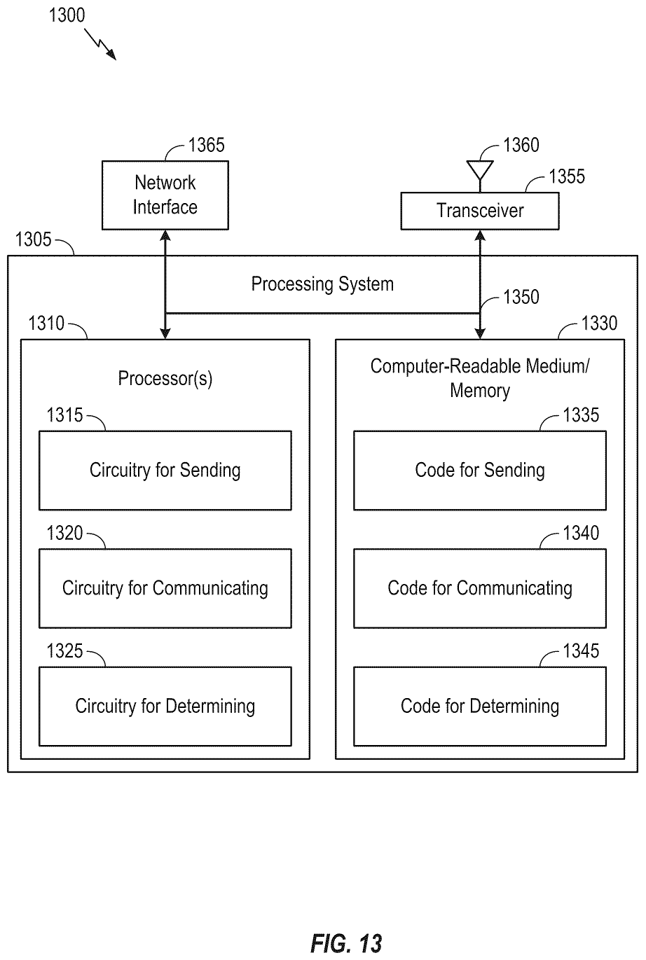

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for receiving 1235, code for communicating 1240, and code for applying 1245. Processing of the code 1235-1245 may enable and cause the communications device 1200 to perform the method 1000 described with respect to FIG. 10, or any aspect related to it. For instance, in some aspects, code for receiving 1235 includes code for receiving, from a NE, an indication of a pi/2-BPSK modulation configuration comprising a phase rotation factor. In some aspects, code for communicating 1240 includes code for communicating in accordance with the pi/2 BPSK modulation configuration.

The one or more processors 1210 include circuitry configured to implement (e.g., execute) the code stored in the computer-readable medium/memory 1230, including circuitry for receiving 1215, circuitry for communicating 1220, and circuitry for applying 1225. Processing with circuitry 1215-1225 may enable and cause the communications device 1200 to perform the method 1000 described with respect to FIG. 10, or any aspect related to it. For instance, in some aspects, circuitry for receiving 1215 includes circuitry for receiving, from a NE, an indication of a pi/2-BPSK modulation configuration comprising a phase rotation factor. In some aspects, circuitry for communicating 1220 includes circuitry for communicating in accordance with the pi/2 BPSK modulation configuration.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1355 (e.g., a transmitter and/or a receiver) and/or a network interface 1365. The transceiver 1355 is configured to transmit and receive signals for the communications device 1300 via an antenna 1360, such as the various signals as described herein. The network interface 1365 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1330. In various aspects, one or more processors 1310 may be representative of the one or more processors 308, as described with respect to FIG. 3. The one or more processors 1310 are coupled to the computer-readable medium/memory 1330 via a bus 1350. In certain aspects, the computer-readable medium/memory 1330 is configured to store instructions (e.g., computer-executable code), including code 1335-1345, that when executed by the one or more processors 1310, cause the one or more processors 1310 to perform the method 1100 described with respect to FIG. 11, or any aspect related to it, including any operations described in relation to FIG. 11. The computer-readable medium/memory 1330 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1330 stores code (e.g., executable instructions), including code for sending 1335, code for communicating 1340, and code for determining 1345. Processing of the code 1335-1345 may enable and cause the communications device 1300 to perform the method 1100 described with respect to FIG. 11, or any aspect related to it. For instance, in some aspects, code for sending 1335 includes code for sending, to a UE, an indication of a pi/2-BPSK modulation configuration comprising a phase rotation factor. In some aspects, code for communicating 1340 includes code for communicating with the UE in a MU-MIMO communication mode in accordance with the pi/2 BPSK modulation configuration.

The one or more processors 1310 include circuitry configured to implement (e.g., execute) the code stored in the computer-readable medium/memory 1330, including circuitry for sending 1315, circuitry for communicating 1320, and circuitry for determining 1325. Processing with circuitry 1315-1325 may enable and cause the communications device 1300 to perform the method 1100 described with respect to FIG. 11, or any aspect related to it. For instance, in some aspects, circuitry for sending 1315 includes circuitry for sending, to a UE, an indication of a pi/2-BPSK modulation configuration comprising a phase rotation factor. In some aspects, circuitry for communicating 1320 includes circuitry for communicating with the UE in a MU-MIMO communication mode in accordance with the pi/2 BPSK modulation configuration.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1355, antenna 1360, and/or network interface 1365 of the communications device 1300 in FIG. 13, and/or one or more processors 1310 of the communications device 1300 in FIG. 13.

### Example Clauses

Implementation examples are described in the following numbered clauses:

Clause 1: A method of wireless communications by a UE, comprising: receiving, from a NE, an indication of a pi/2 BPSK modulation configuration comprising a phase rotation factor; and communicating in accordance with the pi/2 BPSK modulation configuration.

Clause 2: The method of Clause 1, wherein communicating in accordance with the pi/2 BPSK modulation configuration comprises communicating in a multiple user MIMO operation mode.

Clause 3: The method of Clause 2, wherein the multiple user MIMO operation mode is associated with the UE and a co-scheduled UE.

Clause 4: The method of any one of Clauses 1-3, wherein the phase rotation factor corresponds to a codebook index selected from a codebook, the codebook comprising a set of values mapped to a set of phase rotation factors.

Clause 5: The method of any one of Clauses 1-4, wherein the pi/2 BPSK modulation configuration is indicated via a DCI message, wherein the DCI message comprises one or more bits that indicate the phase rotation factor.

Clause 6: The method of Clause 5, wherein the phase rotation factor is indicated in a TPMI field of the DCI message.

Clause 7: The method of any one of Clauses 1-6, wherein the pi/2 BPSK modulation configuration is based on the UE having a capability for coherent transmission over time.

Clause 8: The method of any one of Clauses 1-7, wherein communicating in accordance with the pi/2 BPSK modulation configuration further comprises: applying the phase rotation factor to a first transmission; and applying a second phase rotation factor to a second transmission, wherein the second phase rotation factor is indicated by the pi/2 BPSK modulation configuration.

Clause 9: The method of Clause 8, wherein the phase rotation factor is equal to the second phase rotation factor.

Clause 10: A method of wireless communications by a NE comprising: sending, to a UE, an indication of a pi/2 BPSK modulation configuration comprising a phase rotation factor; and communicating with the UE in a MU-MIMO communication mode in accordance with the pi/2 BPSK modulation configuration.

Clause 11: The method of Clause 10, further comprising determining that a first phase rotation for a first transmission associated with the UE aligns with a second phase rotation for a second transmission associated with a co-scheduled UE based on a first SRS associated with a first channel of the UE and a second SRS associated with a second channel of the co-scheduled UE, wherein the phase rotation factor is based on the first phase rotation or the second phase rotation.

Clause 12: The method of any one of Clauses 10-11, further comprising sending, to a co-scheduled UE associated with an MU-MIMO communication, another indication of another pi/2 BPSK modulation configuration comprising a second phase rotation factor.

Clause 13: The method of any one of Clauses 10-12, wherein the phase rotation factor corresponds to a codebook index selected from a codebook, the codebook comprising a set of values mapped to a set of phase rotation factors.

Clause 14: The method of any one of Clauses 10-13, wherein the pi/2 BPSK modulation configuration is indicated via a DCI message, wherein the DCI message comprises one or more bits that indicate a selected phase rotation factor.

Clause 15: The method of any one of Clauses 10-14, wherein the phase rotation factor causes a first transmission associated with the UE to be orthogonal to a second transmission associated with a co-scheduled UE, wherein the co-scheduled UE and the UE are associated with an MU-MIMO communication.

Clause 16: The method of Clause 15, wherein the pi/2 BPSK modulation configuration is based on the UE and the co-scheduled UE having a capability for coherent transmission over time.

Clause 17: The method of any one of Clauses 10-16, wherein the pi/2 BPSK modulation configuration comprises: the phase rotation factor for a first transmission associated with a first transmitting antenna of the UE; and a second phase rotation factor for a second transmission associated with a second transmitting antenna of the UE, wherein the second phase rotation factor is indicated by the pi/2 BPSK modulation configuration.

Clause 18: The method of Clause 17, wherein the phase rotation factor and the second phase rotation factor are associated with respective indicated codebook indexes selected from a codebook, the codebook comprising a set of values mapped to a set of phase rotation factors.

Clause 19: The method of Clause 17, wherein the second phase rotation factor causes the second transmission to be orthogonal to a third transmission associated with a co-scheduled UE.

Clause 20: The method of Clause 14, wherein the phase rotation factor is indicated in a TPMI field of the DCI message.

Clause 21: One or more apparatuses, comprising: one or more memories comprising executable instructions; and one or more processors configured to execute the executable instructions and cause the one or more apparatuses to perform a method in accordance with any one of Clauses 1-20.

Clause 22: One or more apparatuses configured for wireless communications, comprising: one or more memories; and one or more processors, coupled to the one or more memories, configured to cause the one or more apparatuses to perform a method in accordance with any one of Clauses 1-20.

Clause 23: One or more apparatuses configured for wireless communications, comprising: one or more memories; and one or more processors, coupled to the one or more memories, configured to perform a method in accordance with any one of Clauses 1-20.

Clause 24: One or more apparatuses, comprising means for performing a method in accordance with any one of Clauses 1-20.

Clause 25: One or more non-transitory computer-readable media comprising executable instructions that, when executed by one or more processors of one or more apparatuses, cause the one or more apparatuses to perform a method in accordance with any one of Clauses 1-20.

Clause 26: One or more computer program products embodied on one or more computer-readable storage media comprising code for performing a method in accordance with any one of Clauses 1-20.

Clause 27: One or more apparatuses configured for wireless communications, comprising: a processing system that includes one or more processors and one or more memories coupled with the one or more processors, the processing system configured to cause the one or more apparatuses to perform a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising a processing system that includes one or more processors and one or more memories coupled with the one or more processors, the processing system configured to cause a user equipment (UE) to:
receive, from a network entity (NE), an indication of a pi/2-binary phase shift keying (BPSK) modulation configuration comprising a phase rotation factor; and
communicate in accordance with the pi/2 BPSK modulation configuration.

2. The apparatus of claim 1, wherein to cause the UE to communicate in accordance with the pi/2 BPSK modulation configuration, the processing system is configured to cause the UE to communicate in a multiple user multiple-input multiple-output (MIMO) operation mode.

3. The apparatus of claim 2, wherein the multiple user MIMO operation mode is associated with the UE and a co-scheduled UE.

4. The apparatus of claim 1, wherein the phase rotation factor corresponds to a codebook index selected from a codebook, the codebook comprising a set of values mapped to a set of phase rotation factors.

5. The apparatus of claim 1, wherein the pi/2 BPSK modulation configuration is indicated via a downlink control information (DCI) message, wherein the DCI message comprises one or more bits that indicate the phase rotation factor.

6. The apparatus of claim 5, wherein the phase rotation factor is indicated in a transmission precoding matrix indicator (TPMI) field of the DCI message.

7. The apparatus of claim 1, wherein the pi/2 BPSK modulation configuration is based on the UE having a capability for coherent transmission over time.

8. The apparatus of claim 1, wherein to cause the UE to communicate in accordance with the pi/2 BPSK modulation configuration, the processing system is configured to cause the UE to:
apply the phase rotation factor to first modulation symbols of a first transmission; and
apply a second phase rotation factor to second modulation symbols of a second transmission, wherein the second phase rotation factor is indicated by the pi/2 BPSK modulation configuration.

9. The apparatus of claim 8, wherein the phase rotation factor is equal to the second phase rotation factor.

10. An apparatus configured for wireless communication, comprising a processing system that includes one or more processors and one or more memories coupled with the one or more processors, the processing system configured to cause a network entity (NE) to:
send, to a user equipment (UE), an indication of a pi/2-binary phase shift keying (BPSK) modulation configuration comprising a phase rotation factor; and
communicate with the UE in a multiple user multiple-input multiple-output (MU-MIMO) communication mode in accordance with the pi/2 BPSK modulation configuration.

11. The apparatus of claim 10, wherein the processing system is further configured to cause the NE to determine that a first phase rotation for a first transmission associated with the UE aligns with a second phase rotation for a second transmission associated with a co-scheduled UE based on a first sounding reference signal (SRS) associated with a first channel of the UE and a second SRS associated with a second channel of the co-scheduled UE, wherein the phase rotation factor is based on the first phase rotation or the second phase rotation.

12. The apparatus of claim 10, wherein the processing system is further configured to cause the NE to send, to a co-scheduled UE associated with an MU-MIMO communication, another indication of another pi/2 BPSK modulation configuration comprising a second phase rotation factor.

13. The apparatus of claim 10, wherein the phase rotation factor corresponds to a codebook index selected from a codebook, the codebook comprising a set of values mapped to a set of phase rotation factors.

14. The apparatus of claim 10, wherein the pi/2 BPSK modulation configuration is indicated via a downlink control information (DCI) message, wherein the DCI message comprises one or more bits that indicate a selected phase rotation factor.

15. The apparatus of claim 10, wherein the phase rotation factor causes a first transmission associated with the UE to be orthogonal to a second transmission associated with a co-scheduled UE, wherein the co-scheduled UE and the UE are associated with an MU-MIMO communication.

16. The apparatus of claim 15, wherein the pi/2 BPSK modulation configuration is based on the UE and the co-scheduled UE having a capability for coherent transmission over time.

17. The apparatus of claim 10, wherein the pi/2 BPSK modulation configuration comprises:
the phase rotation factor for first modulation symbols of a first transmission of the UE; and
a second phase rotation factor for second modulation symbols of a second transmission of the UE, wherein the second phase rotation factor is indicated by the pi/2 BPSK modulation configuration.

18. The apparatus of claim 17, wherein the phase rotation factor and the second phase rotation factor are associated with respective indicated codebook indexes selected from a codebook, the codebook comprising a set of values mapped to a set of phase rotation factors.

19. The apparatus of claim 14, wherein the phase rotation factor is indicated in a transmission precoding matrix indicator (TPMI) field of the DCI message.

20. A method of wireless communications by a user equipment (UE), comprising:
receiving, from a network entity (NE), an indication of a pi/2-binary phase shift keying (BPSK) modulation configuration comprising a phase rotation factor; and
communicating in accordance with the pi/2 BPSK modulation configuration.
